(19) United States
(12) Patent Application Publication
(10) Pub. No.: US 2024/0280228 A1
(43) Pub. Date: Aug. 22, 2024

(54) ATTACHABLE LIGHT SOURCE DEVICE

(71) Applicant: Susan Herson, Ithaca, NY (US)

(72) Inventor: Susan Herson, Ithaca, NY (US)

(21) Appl. No.: 18/443,964

(22) Filed: Feb. 16, 2024

Related U.S. Application Data
(60) Provisional application No. 63/446,667, filed on Feb. 17, 2023.

(51) Int. Cl. F21L 4/04; F21L 4/08; F21V 21/08; F21V 21/35; F21V 23/04; F21W 111/10; F21Y 115/10; G01S 19/42

(52) U.S. Cl. CPC F21L 4/045; F21L 4/085; F21V 21/08; F21V 21/35; F21V 23/0428; F21V 23/0485; G01S 19/42; F21W 2111/10; F21Y 2115/10

(57) ABSTRACT

A light source device may be provided herein. The light source device may be an attachable light source device. The light source device may comprise a body with a movable, activatable light source coupled to the body. The light source may comprise a first light emission in a standby power mode, a second, brighter light emission in an active power mode, and no light emission in an off power mode. A button may be located on the light source device and configured to change the power mode of the light source. The light source device may comprise an attachment device configured to removably couple the light source device to another device.

### CROSS REFERENCE TO RELATED APPLICATIONS

This application claims the benefit of U.S. Patent Application No. 63/446,667, filed Feb. 17, 2023, which is incorporated herein by reference in its entirety.

### FIELD OF THE DISCLOSURE

The present invention relates to embodiments of a light source device that aids in navigating obstacles in an environment. For example, the light source device may comprise a cane with any number of features, described in further detail below, built into the cane. The light source device may comprise an attachable light source device/aid that can attach to a variety of equipment, including but not limited to, mobility devices such as canes, walkers, crutches, and/or wheelchairs. The attachable light source device may also be attached to other items, including, but not limited to poles, skis, bikes, sports equipment, furniture, motor vehicles, backpacks, bags, and/or clothing. In a non-limiting embodiment, the device may include a reflective, glow in the dark material to make the device automatically visible in the dark. The device may further include, in addition to the reflective, glow in the dark elements, an activatable light source. In addition to, or alternatively, the activatable light source may emit a low level of light in a standby state, and the activatable light source may emit a higher level of light in an active state. Further, the light source device may be adjustable and rotatable in its orientation even when attached to another item such that the direction that the light may be aimed in different directions as desired by the user.

### BACKGROUND

There is a myriad of mobility devices and light sources (e.g., flashlights) that are available that are supposed to assist individuals to see in the dark. However, many of such mobility devices do not take into consideration that individuals who have dementia, Alzheimer's, arthritis, including in the hands or joints, or other physical ailments and conditions may not be able operate the device easily or see the device in the dark to benefit from such mobility devices.

Accordingly, there is a need for an improved attachable light source device that may be attached to a variety of items and that includes features to assist users with impaired mobility or vision to find and locate the attachable light source device. Additionally, or alternatively, there is a need for an improved mobility device with features that may aid the users with impaired mobility or vision to navigate an environment while avoiding obstacles and injury.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a block diagram of an attachable light source device.

FIG. 2 depicts a pictorial illustration of a first exemplary embodiment of an attachable light source device.

FIG. 3 depicts a pictorial illustration of a front view of the example attachable light source device shown in FIG. 2.

FIG. 4 depicts a pictorial illustration of a side view of the example attachable light source device shown in FIG. 2.

FIG. 5 depicts a pictorial illustration of the rotatability of the example attachable light source device shown in FIG. 2.

FIG. 6 depicts a pictorial illustration of a second exemplary embodiment of an attachable light source device.

FIG. 7 depicts a pictorial illustration of a third exemplary embodiment of an attachable light source device.

FIG. 8 depicts a pictorial illustration of a fourth exemplary embodiment of an attachable light source device.

FIG. 9 depicts a fifth exemplary embodiment of an attachable light source device.

FIG. 10A depicts a side view of the fifth exemplary embodiment of the attachable light source device shown in FIG. 9.

FIG. 10B depicts a front view of the fifth exemplary embodiment of the attachable light source device shown in FIG. 9.

FIG. 10C depicts a back view of the fifth exemplary embodiment of the attachable light source device shown in FIG. 9.

FIG. 10D depicts a top view of the fifth exemplary embodiment of the attachable light source device shown in FIG. 9.

FIG. 10E depicts a bottom view of the fifth exemplary embodiment of the attachable light source device shown in FIG. 9.

FIG. 11 depicts a first exemplary cane device with a light source built-in to the cane.

FIG. 12 depicts a second exemplary cane device with a light source built-in to the cane.

FIG. 13 depicts a third exemplary cane device with a light source built-in to the cane.

FIG. 14 depicts a fourth exemplary cane device with a light source built-in to the cane.

FIG. 15A depicts an anti-tip feature that may be incorporated into any of the light source devices described herein.

FIG. 15B depicts a second view of the anti-tip feature.

### DETAILED DESCRIPTION

The present description is drawn to a novel attachable light source that can greatly assist a variety of users to have a light source that is attachable to different items and that includes both a separate activatable light source and a phosphorescent (i.e. glow in the dark) material to allow the attachable light source to be visible in the dark even if the integrated activatable light source is powered off. In one or more non-limiting embodiments, the attachable light source also is rotatable so that the field of light provided by the attachable light source can be adjusted and directed where best required by the user. Further, in one or more non-limiting embodiments, the attachable light source is configured to be removably attachable to various items, including, but not limited to, cylindrically shaped members such as the poles and rods found on canes, walkers, wheel chairs, and/or crutches. The attachable light source may also be attachable to a number of other items as well as noted above. Further, in one or more non-limiting embodiments, the attachable light source may include a rechargeable battery. The light source device may further comprise a pole or cane with features of the light source device included therein. For example, the light source device may be a cane with a light source built into the cane. The light source device may be a cane with a geographical locating system, for example a global positioning system (GPS), built into the cane. The light source device may be a cane with a built-in alarm system. The light source device may be a cane with a built-in anti-tip feature.

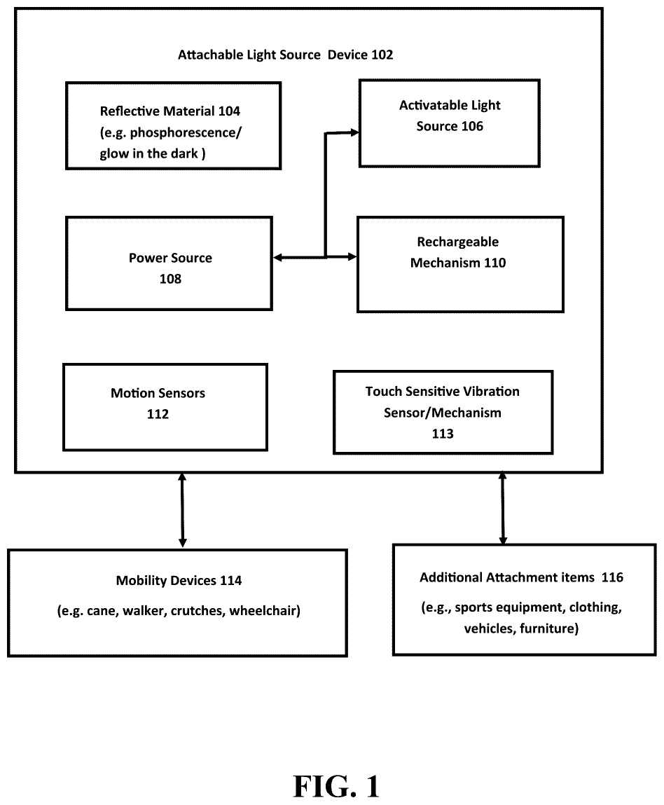

FIG. 1 provides a block diagram of an exemplary attachable light source device 102. In a non-limiting embodiment, the attachable light source device is intended to be removably attachable to a variety of mobility devices 114. Examples of mobility devices 114 include, but are not limited to, walkers, canes, crutches, and wheelchairs. These mobility devices 114 are commonly used by anyone with a physical ailment or disability who may need assistance with walking or moving or who have comprised mobility. Such mobility devices 114 are also commonly used by the elderly, who have well known issues with respect to moving unassisted from place to place. The mobility devices 114 are useable for the elderly or any individual who needs assistance with their mobility and the stability provided by the mobility devices 114. In a non-limiting embodiment, the attachable light device 102 may be removably attachable to any of the structural members (e.g., rods or members or poles) of the mobility devices 114.

Notably, the attachable light source device 102 may be attached to a variety of other items 116 other than mobility devices 114. Such items 116 may include furniture structures, such as staircases, doorframes, window frames, chairs, tables, sofas, or any type of furniture. Such items 116 may include sports equipment, such as, but not limited to, bicycles, ski poles, exercise equipment, or any type of sports equipment. Further, the attachable light source device 102 may be attachable to clothing and/or the interior of vehicles. Advantageously, there are multiple types of items where it may be useful to attach the attachable light source device 102 to provide additional light for improved visibility to the user.

The attachable light source device 102 is adapted to advantageously provide multiple sources of light for the user. In a non-limiting embodiment, the attachable light source device 102 has both reflective material 104 integrated into the outside body of the attachable light source device 102 and also a separate activatable light source 106 integrated into the attachable light source device 102. The reflective material 104, in a non-limiting embodiment, has glow in the dark elements so that the reflective material 104 is visible to the user in the dark without any additional input from the user. The reflective material 104 may utilize phosphorescence which provides the natural glow in the dark aspect to the removable and attachable light source device 102. Accordingly, the attachable light source device 102 may have a sleeve or another portion of the body of the attachable light source device 102 that incorporates phosphorescence, which would render the attachable light source device 102 automatically visible to anyone in the dark. The phosphorescent material 104 is visible from the exterior of the attachable light source device 102 and may be included on a larger portion or a smaller portion of the attachable light source device 102 in one or more non-limiting embodiments.

Further, the attachable light source 102 may include a separate attachable light source (e.g., similar to a flashlight) in addition to the reflective material 104 integrated into the attachable light source device 102. The separate attachable light 106 may include one or more lights covered in one or more lenses that is connectable to a power source 108. The separate attachable light 106 would be activatable and can be powered on and off either through manual input from the user or in one or more non-limiting embodiments, may be activated via motion and/or vibration. In a non-limiting embodiment, there may be motion sensors 112 integrated into the body of the attachable light source device 102 able to activate the activatable light source 106 when any motion is sensed by the motion sensors 112.

Alternatively, or additionally, there may also be a touch sensitive vibration sensor/mechanism 113 integrated into the body of the attachable light source device 102. The touch sensitive vibration sensor/mechanism 113 may be engineered to be sensitive to touch imparted to either the attachable light source device 102 or to the mobility device 114 that the attachable light source 102 is attached to. Advantageously, if the user were to touch or grab either the walker, cane, walker, or wheelchair (i.e., mobility devices 114) that the attachable light source device 102 is attached to or to grab or touch any part of the attachable light source device 102, the activatable light source device 102 may turn on automatically due to the sensing of the touch on either the activatable light source device 102 or the mobility device 114. Such a feature may be advantageous even over a motion sensor 112 that is motion activated because the light from the activatable light source 106 may only be activated when the user truly desires by touch or contact rather than turning on or off due to any random motion sensed by a motion sensor 112. Further, if a mobility device 114 or other item 116 that the attachable light source 102 is connected to happens to fall over, the attachable light source device 102 may vibrate when the touch sensitive vibration sensor/mechanism 113 is included and thereby help to alert the user or other party that the mobility device 114 has fallen over.

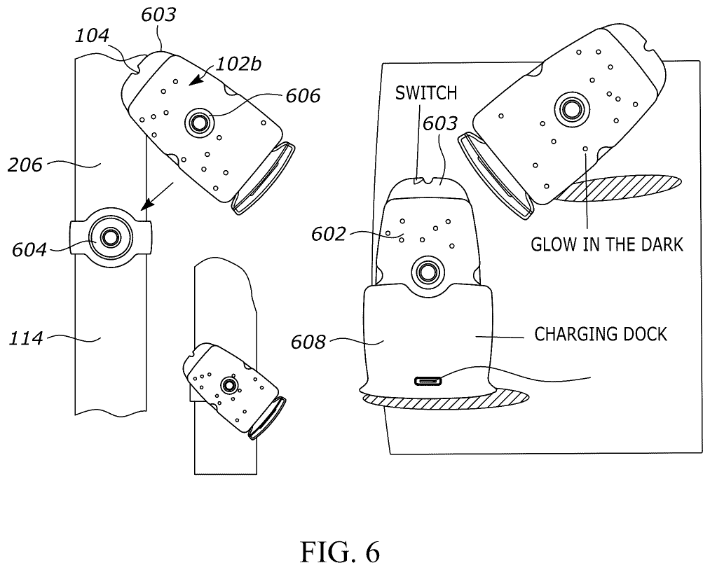

The power source 108 may provide power directly to the activatable light source 106. In a non-limiting embodiment, the power source 108 may include non-rechargeable, replaceable batteries. In other non-limiting embodiments, the power source 108 may include rechargeable batteries. In a non-limiting embodiment, the rechargeable battery may be separately removable and chargeable apart from the body of the attachable light source device 102. In other non-limiting embodiments, the attachable light source device 102 may have a rechargeable mechanism 110 that allows the power source 108 of the activatable light source 106 to be recharged. For example, FIG. 6 shows a first non-limiting embodiment for an attachable light source device 102 that has a charging dock 608 that can be used to charge the power source 108 of the attachable light source device 102.

Additionally, in one or more non-limiting embodiments, the attachable light source device 102 may attach to a charging cord that can connect to an electrical outlet to charge the power source 108 of the attachable light source device 102. In non-limiting embodiment, the charging cord type may be a USB-C charging cord type.

In other cases, there may be charging base(s) associated with the attachable light source device 102 to recharge the power source 108 of the attachable light source device 102. Further, in a non-limiting embodiment, the power source 108 of the attachable light source device 102 may be rechargeable using a snap-on magnetic charging cord.

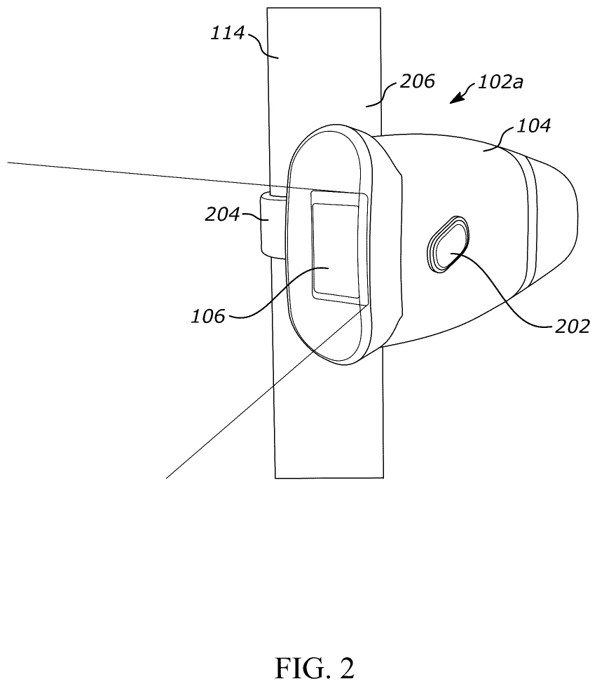

The attachable light source device 102 may be attached to the poles or members of mobility devices 114 and/or other items 116 using a number of attachment mechanisms. In some instances, the attachable light source device 102 may be attachable using straps (e.g., strap 204 shown in FIG. 2) that attach to one or more sides of the attachable light source device 102. In other instances, the attachable light source device 102 may be attachable using clips, magnets, fasteners, and other attachment mechanisms.

FIGS. 2-5 illustrate a first exemplary embodiment 102a of an attachable light source device 102. As shown in FIG. 2, the attachable light source device 102 may be particularly useful for illumination in dark environments to assist the user. As shown in FIG. 2, the first embodiment of the attachable light source device 102a is attached with a strap 204 that connects one side of the attachable light source device 102a to a pole member 206 of a mobility device 114 (e.g., cane, walker, wheelchair, or crutches). The body of the first embodiment of the attachable light source device 102a may be lightweight and grippable with one hand. The activatable light source 106 has a field of light that can illuminate in a forward direction. A power on/off button or other type of selector is included on the outside of the body of the attachable light source device 102a. The reflective/phosphorescent material 104 is integrated onto an outside of the body of the first embodiment of the attachable light source device 102a. As noted above, it is advantageous that the reflective/phosphorescent material 104 may make the attachable light source device 102 and any items that the attachable light source device 102 is attached to visible on their own even if the activatable light source 106 is powered off.

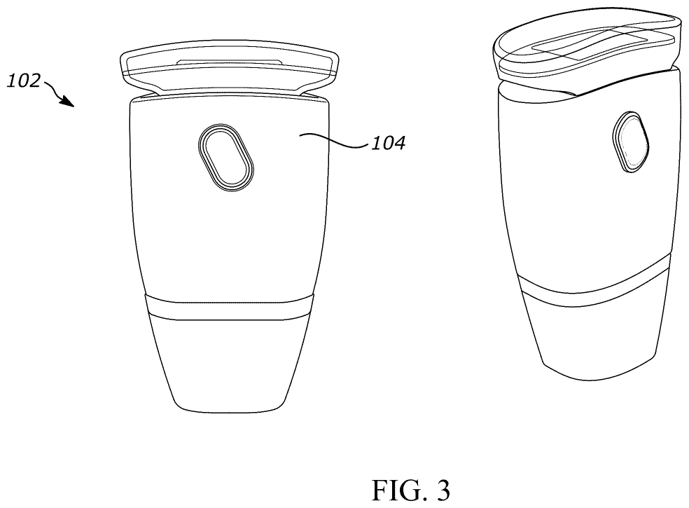

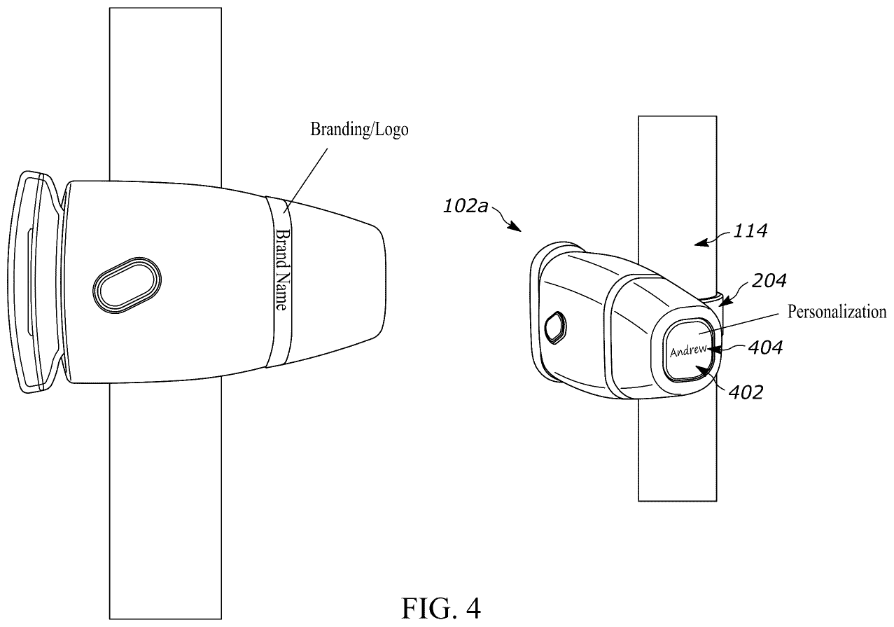

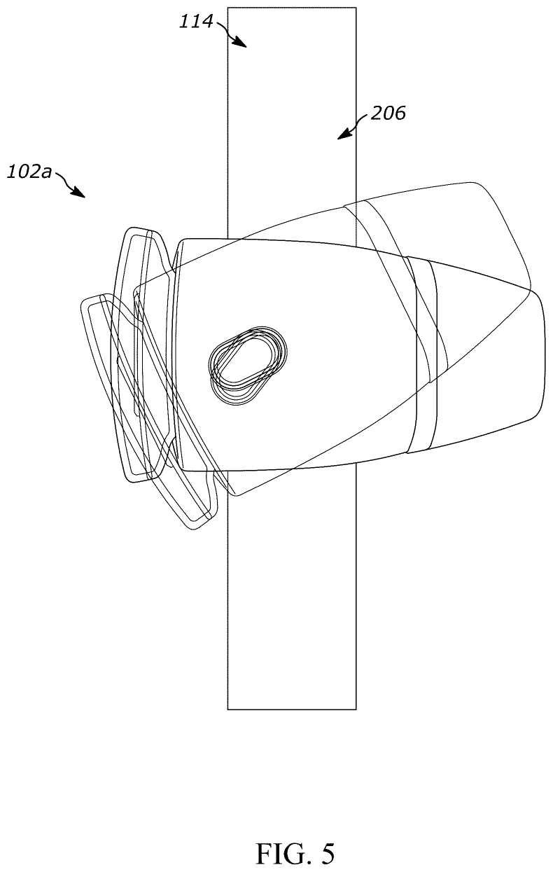

FIG. 3 illustrates that the attachable light source 102a may stand upright on its own on a surface. FIG. 4 illustrates that the attachable light source 102a may include a personalizable base 404 located on an underside of the attachable light source device 102a. The personalizable base 404 may include an indicia 404 of personalization. For example, a name of the user and/or owner of the attachable light source device 102a may be included on a personalizable base 404. This may be particularly helpful for any user who is elderly or has dementia and requires assistance using mobility devices 114. The personalizable base 404 may clearly and visibly indicate the identity of the user associated with the attachable light source device 102a. FIG. 5 illustrates that the first embodiment of the attachable light source device 102a may be adjusted and/or rotated relative to a pole member 206 so that the field of light provided by the activatable light source 106 is directed in the direction that is particularly beneficial for the user. For instance, a user may prefer that the attachable light source device 102a is rotated to point downward while attached to the mobility device 114, so that the field of light provided by the activatable light source 106 within the attachable light source device 102a is directed towards the floor surface and illuminates the direction that the user is moving in. Further, as illustrated in FIG. 3, there are opportunities for companies or other entities to advertise or include their brands on the outside of the attachable light source device 102a.

FIG. 6 illustrates a second exemplary embodiment of an attachable light source device 102b. As shown in FIG. 6, the second embodiment 102b may be rotatable and removably attachable to the pole member 206 of a mobility device 114 or another item 116 as needed by a user. The second embodiment of an attachable light source device 102b may be connectable to the pole member 206 or another structure via a magnetizable strap 604. The magnetizable strap 604 may attach around the pole member 206 and the mating portion 606 on the body of the second embodiment of the attachable light source device 102b may removably attach to the magnetizable strap 604. Further, FIG. 6 shows how the attachable light source device 102b may include a charging dock 608 to charge the power source 108 within the attachable light source device 102b. Further, in FIG. 6, the phosphorescent, glow in the dark material is included on an end portion of the attachable light source device 102b and is visible from a back or rear of the attachable light source device 102b. Additionally, the back or rear of the attachable light source device 102b may also encompass the power on/off switch to turn the activatable light source 106 on or off.

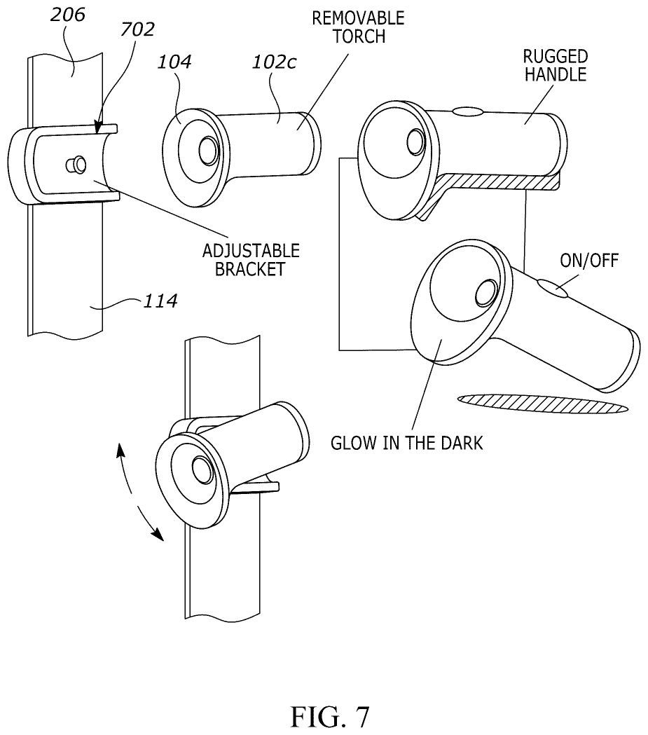

FIG. 7 shows a third exemplary embodiment of an attachable light source device 102c. In the third embodiment 102c shown in FIG. 7, the attachable light source device 102c is in the form of a removable torch or flashlight with a rugged handle, and on/off switch, and reflective/phosphorescent material 104. The third embodiment 102c connects to an adjustable bracket 702, in one or more non-limiting embodiments, which can be removably attached to a pole member 206 of a mobility device 114 or to another item 116 in one or more non-limiting embodiments. The third embodiment 102c can rotate while contained within the adjustable bracket 702 so that the user can adjust the direction of orientation of the field of light provided by the activatable light source 106 integrated into the third embodiment of the attachable light source device 102c.

As shown in FIG. 7, in a non-limiting, exemplary embodiment, the phosphorescent material 104 may encircle or surround the front side of the lens of the attachable light source device 102c.

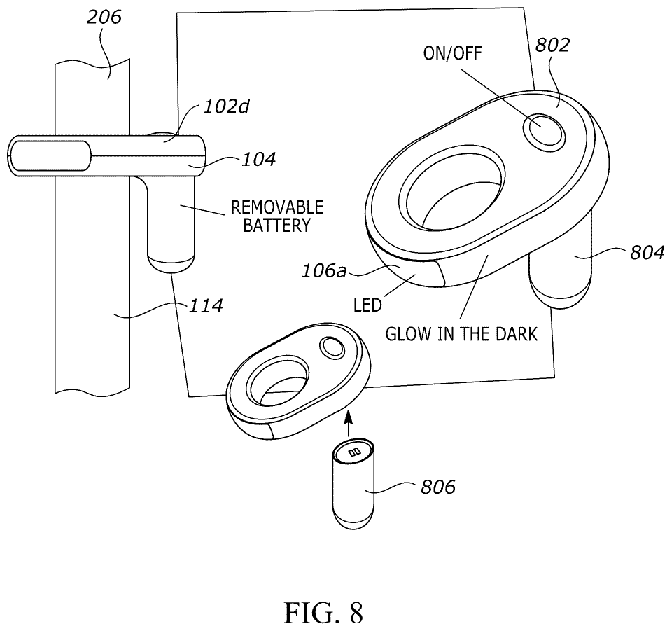

FIG. 8 shows a fourth exemplary embodiment for an attachable light source device 102d. As shown in FIG. 8, the fourth embodiment 102d may include a different structure in that the body of the top portion of the attachable light source device 102d can open and close around a pole member 206 of a mobility device 114 and may attach to the mobility device 114 in this manner. In the non-limiting example shown in FIG. 8, a power on/off selector 802 is located on a top surface of the body of the attachable light source device 102d. The reflective/phosphorescent material 104 is integrated into and surrounds the sides of the top portion of the fourth embodiment of the attachable light source device 102d. The example shown in FIG. 8 further includes a removable, rechargeable battery 806 that can be charged repeatedly to power the LED light source 106a included with the fourth exemplary embodiment 102d.

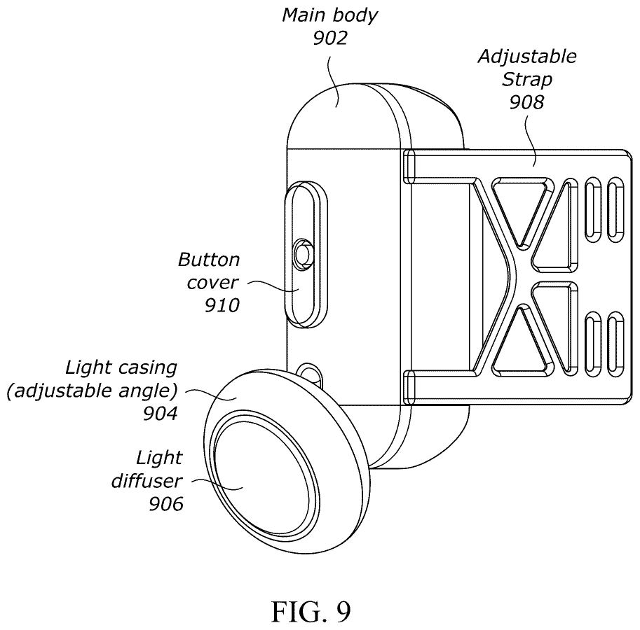

FIG. 9 shows a fifth exemplary embodiment of the attachable light source device in a diagonal view. The attachable light source is shown comprising a light source that is movable separately from movement of the rest of the body of the attachable light source. For example, the attachable light source is shown with a main body 902 that houses portions of the light source. For example, the main body may comprise an electrical component configured to implement some functionalities of the attachable light source device. The main body 902 may comprise an inner space (not shown) that is partially reserved for a battery (also not shown). The battery may be a removable and disposable battery. The battery may be a removable and rechargeable battery. The battery may be integrated with the inner portion of the main body 902, and the battery may be rechargeable using a charging port implemented on an external surface of the main body 902. The main body may be configured to couple with a light casing 904.

The light casing 904 may be movably coupled to the main body 902 at adjustable angles. For example, the light casing 904 may swivel on one axis, the light casing may swivel on two axes, or the light casing 904 may move on more than two axes. In FIG. 9, the light casing 904 is shown in a first configuration, in which the light casing is coupled to a bottom portion of the main body 902, and the light casing may rotate on an axis perpendicular to a length (e.g., a longest axis) of the main body. The attachable light source device may be coupled to another device. For example, the attachable light source device may be coupled to a cane. The attachable light source device may couple to the cane in a configuration that allows the light casing 904 to move along a vertical plane. The light casing 904 may be coupled to the cane such that the light casing 904 faces a same direction of travel as a user using the cane. The light casing 904 may therefore be able to present a light (not shown, but disposed inside the light casing 904) in the direction of travel of the user using the cane. Though the attachable light source device is described as attached to a cane and facing a direction of travel of a user using the cane, the attachable light source device may be coupled to any number of other devices in any number of other directions. For example, the attachable light source device may be coupled to mobility devices other than a cane, for example a walker, crutches, or a wheelchair. The attachable light source device may additionally, or alternatively, be attached to other items, including, but not limited to poles, skis, bikes, sports equipment, furniture, motor vehicles, backpacks, bags, and/or clothing. The attachable light source device may be attached to project light emitting from the light casing 904 backward, sideways, upward, or downward, in addition to, or alternative to, projecting light in a forward direction.

The light, though not shown, may be configured with multiple modes of operation with differing power levels associated with the light. The light may be turned off. In an off power mode the light may not emit light. The light may be in a standby power mode. In the standby power mode the light may emit a dull light. The dull light emitted during the standby mode may be a quantity of light suitable for locating the attachable light source device in a dark environment. The dull light emitted during the standby mode may not be suitable for navigating a dark environment using the attachable light source device in a standby mode. The light may be in an active power mode. In the active power mode the light may emit a bright light. The bright light emitted during the active power mode may be suitable for navigating a dark environment using the attachable light source device. The light may emit from the light diffuser 906.

The light diffuser 906 may act as a cover over the light to diffuse the light emitted from the light. The light diffuser 906 may be translucent, the light diffuser 906 may be partially opaque, or the light diffuser 906 may be opaque. The light diffuser 906 may increase diffusion of light emitted by the attachable light source device, and the light diffuser 906 may aid a user in navigating an environment by diffusing the emitted light in an area forward of a direction of travel of the user. The attachable light source device may be attached to another device via an adjustable strap 908.

The adjustable strap 908 may comprise a stretchable material that may wrap around another device and couple to a latch, hook, clasp, clip, or other catch on an opposite side of the attachable light source device. The adjustable strap 908 may be comprised of a material that has a high coefficient of friction. For example, the adjustable strap 908 may be comprised of rubber, soft plastic, cloth, fabric, or any other suitable material. The adjustable strap 908 may comprise any other suitable type of latching mechanism to couple the attachable light source device to another device. For example, the adjustable strap 908 may comprise a hook and loop fastener. The attachable light source device may comprise a button and a button cover 910.

The button cover 910 may be a transparent, partially opaque, or opaque material covering a power button. The button cover 910 may be comprised of plastic, metal, or any other suitable material. Operation of the button may be configured to alter the power mode of the light of the attachable light source device.

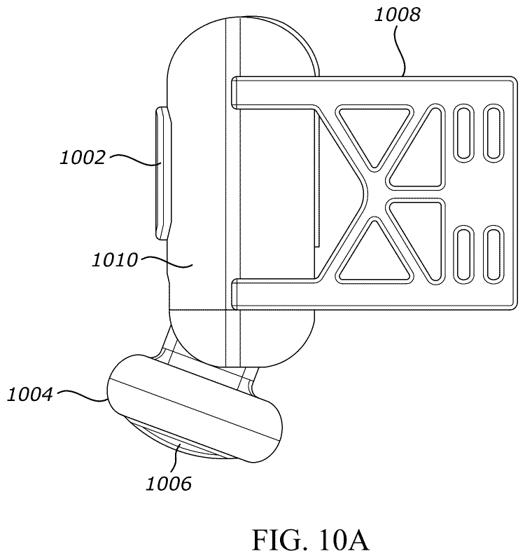

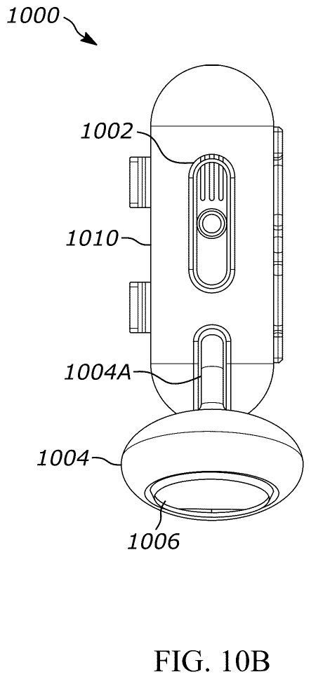

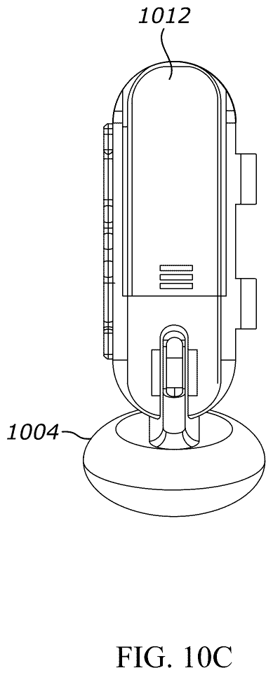

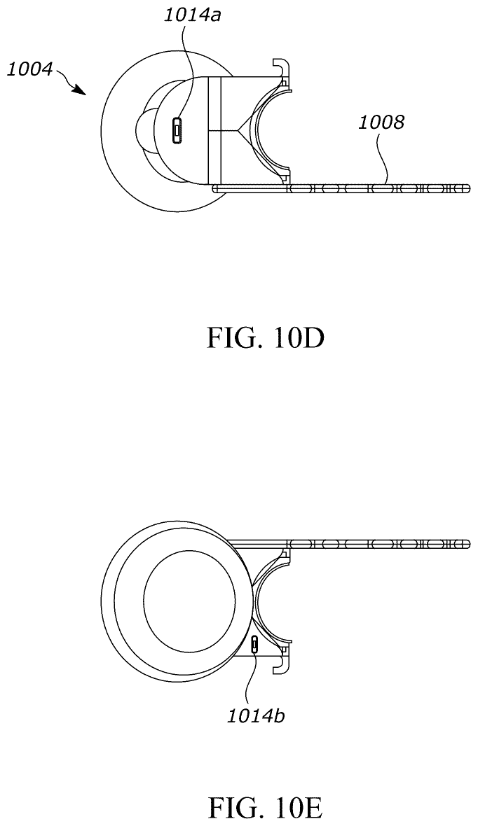

FIG. 10A shows the fifth exemplary embodiment of the attachable light source device in a side view. Power button 1002 is shown partially protruding from the surface of a main body 1010 of the attachable light source device. The power button may be configured to alter a power mode associated with the attachable light source device. The attachable light source device may be configured with multiple modes of operation with differing power levels associated with a light (not shown) of the attachable light source device. The light may be turned off. In an off power mode the light may not emit light. The light may be in a standby power mode. In the standby power mode the light may emit a dull light. The dull light emitted during the standby mode may be a quantity of light suitable for locating the attachable light source device in a dark environment. The dull light emitted during the standby mode may not be suitable for navigating a dark environment using the attachable light source device in a standby mode. The light may be in an active power mode. In the active power mode the light may emit a bright light. The bright light emitted during the active power mode may be suitable for navigating a dark environment using the attachable light source device. The light may emit from the light casing 1004.

The light casing 1004 may be movably coupled to the main body 1010 of the attachable light source device. For example, the light casing 1004 may swivel on one axis, the light casing 1004 may swivel on two axes, or the light casing 1004 may move on more than two axes. In FIG. 10A, the light casing 1004 is shown in a first configuration, in which the light casing 1004 is coupled to a bottom portion of the main body 1010 of the attachable light source device, and the light casing 1004 may rotate on an axis perpendicular to a length (e.g., a longest axis) of the main body 1010 of the attachable light source device. The attachable light source device may be coupled to another device. For example, the attachable light source device may be coupled to a cane. The attachable light source device may couple to the cane in a configuration that allows the light casing 1004 to move along a vertical plane. The light casing 1004 may be coupled to the cane such that the light casing 1004 faces a same direction of travel as a user using the cane. The light casing 1004 may therefore be able to present a light (not shown, but disposed inside the light casing 1004) in the direction of travel of the user using the cane. Though the attachable light source device is described as attached to a cane and facing a direction of travel of a user using the cane, the attachable light source device may be coupled to any number of other devices in any number of other directions. For example, the attachable light source device may be coupled to mobility devices other than a cane, for example a walker, crutches, or a wheelchair. The attachable light source device may additionally, or alternatively, be attached to other items, including, but not limited to poles, skis, bikes, sports equipment, furniture, motor vehicles, backpacks, bags, and/or clothing. The attachable light source device may be attached to project light emitting from the light casing 1004 backward, sideways, upward, or downward, in addition to, or alternative to, projecting light in a forward direction. The light casing 1004 may comprise a light diffuser 1006.

The light diffuser 1006 may act as a cover over the light to diffuse the light emitted from the light source device. The light diffuser 1006 may be translucent, the light diffuser 1006 may be partially opaque, or the light diffuser 1006 may be opaque. The light diffuser 1006 may increase diffusion of light emitted by the attachable light source device, and the light diffuser 1006 may aid a user in navigating an environment by diffusing the emitted light in an area forward of a direction of travel of the user. The attachable light source device may be attached to another device via an adjustable strap 1008.

The adjustable strap 1008 may comprise a stretchable material that may wrap around another device and couple to a latch, hook, clasp, clip, or other catch on an opposite side of the attachable light source device. The adjustable strap 1008 may be comprised of a material that has a high coefficient of friction. For example, the adjustable strap 1008 may be comprised of rubber, soft plastic, cloth, fabric, or any other suitable material. The adjustable strap 1008 may comprise any other suitable type of latching mechanism to couple the attachable light source device to another device. For example, the adjustable strap 1008 may comprise a hook and loop fastener.

FIG. 10B shows the fifth exemplary embodiment of the attachable light source device 1000 in a front view. A power button 1002 is shown in a generally oval configuration. The power button 1002 may protrude from the main body 1010 of the attachable light source device 1000 for ease of use. The power button 1002 may be coupled to a front of the attachable light source device 1000. A light casing 1004 is coupled to a lower portion of the main body 1010.

The light casing 1004 may be movable with respect to the main body 1010. For example, the light casing 1004 may comprise an arm 1004A coupled to a rotational axis. The arm 1004A may be positioned partially inside the main body 1010 of the attachable light source device. The light casing may comprise a light diffuser 1006. The light diffuser may diffuse light emitted from a light source within the light casing 1004. The light casing may be moved to a position to illuminate an environment ahead of a direction of travel of a user using the attachable light source device 1000.

FIG. 10C shows the fifth exemplary embodiment of the attachable light source device 1000 in a back view. The light casing 1004 is shown from a slightly top-down angle and shows an example of an arm coupling the light casing 1004 to a main body of the attachable light source device. The light casing 1004 may be movable along an axis defined by the arm coupled to the main body of the attachable light source device. Additionally, the back view shows a back face 1012 of the attachable light source device that may be in communication with another device when the attachable light source device is coupled to the another device. For example, the back face 1012 of the attachable light source device may be curved to provide a more consistent communication between the back face 1012 and the another device. For example, the curved back face 1012 may touch the another device at a greater area of the back face 1012 than an embodiment with a flat back face. The back face 1012 may comprise a material with a high coefficient of friction. For example, the back face 1012 may be comprised of rubber, soft plastic, or any other suitable material to provide friction between the attachable light source device and the another device. The back face 1012 may be removable to access an inner portion of the attachable light source device. For example, the back face 1012 may be removable to interact with a battery inside the attachable light source device. The battery may be removed, replaced, or recharged. The back face 1012 may be removable to provide access for a user to interact with an inner circuitry of the attachable light source device.

FIG. 10D shows the fifth exemplary embodiment of the attachable light source device 1000 in a top view. The light casing 1004 is shown in a back plane of the Figure, denoting the light casing 1004 is located at a bottom of the attachable light source device. The top view shows a charging port 1014a, used to charge the electronic features of the attachable light source device. For example, a suitable electrical cable may removably couple to the charging port 1014a to provide power to a battery located inside the attachable light source device. For example, the charging port 1014a may comprise a universal serial bus (USB)-A port, a USB-B port, a mini-USB port, a micro-USB port, a USB-C port, a lightning port, or the like. The top view of the attachable light source device shows an adjustable strap 1008 partially coupled to a first side of the attachable light source device.

The adjustable strap 1008 may comprise a stretchable material that may wrap around another device and couple to a latch, hook, clasp, clip, or other catch on an opposite side of the attachable light source device. The adjustable strap 1008 may be comprised of a material that has a high coefficient of friction. For example, the adjustable strap 1008 may be comprised of rubber, soft plastic, cloth, fabric, or any other suitable material. The adjustable strap 1008 may comprise any other suitable type of latching mechanism to couple the attachable light source device to another device. For example, the adjustable strap 1008 may comprise a hook and loop fastener.

FIG. 10E shows the fifth exemplary embodiment of the attachable light source device 1000 in a bottom view. The bottom view shows a charging port 1014b, used to charge the electronic features of the attachable light source device. For example, a suitable electrical cable may removably couple to the charging port 1014b to provide power to a battery located inside the attachable light source device. For example, the charging port 1014b may comprise a universal serial bus (USB)-A port, a USB-B port, a mini-USB port, a micro-USB port, a USB-C port, a lightning port, or the like. Though FIGS. 10D and 10E both show charging ports, the attachable light source device may comprise solely a charging port 1014a on the top of the device, a charging port 1014b on the bottom of the device, both charging ports 1014a and 1014b on the top and bottom of the device, or neither of the charging ports 1014a and 1014b.

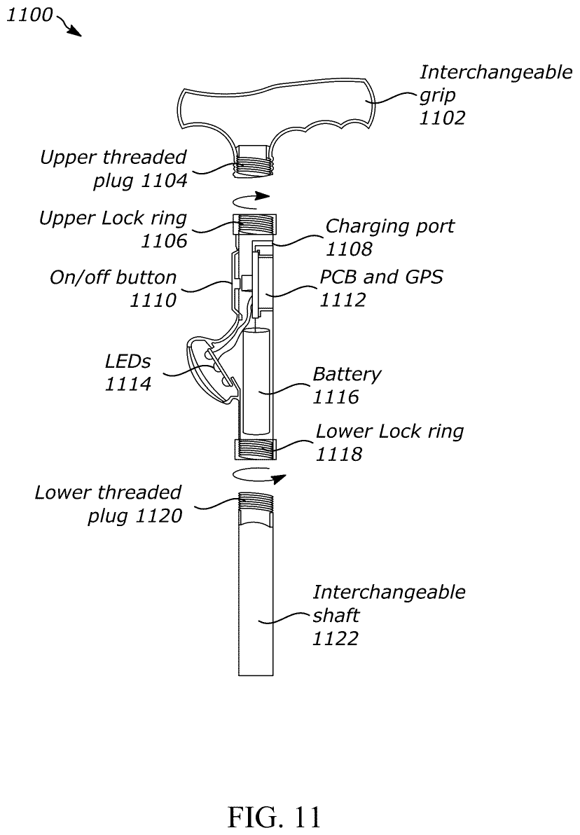

FIG. 11 shows an example light source mobility device 1100. The light source mobility device 1100 may be configured to implement any one or more of the features of the attachable light source device noted above, with any one or more of the features of the attachable light source device built into the light source mobility device 1100. For example, the light source mobility device 1100 may be a cane with any one or more of the features of the attachable light source device built-in. The light source mobility device 1100 is shown as a cane in FIG. 11, but the light source mobility device 1100 may be implemented as any suitable mobility device. For example, the features of the light source mobility device 1100 may be implemented in a walker, crutches, or a wheelchair.

The light source mobility device 1100 comprises an interchangeable grip 1102. The interchangeable grip 1102 may comprise a handle and an upper threaded plug 1104. The upper threaded plug 1104 may allow the interchangeable grip to be screwed on to (and off of) the light source mobility device 1100. The interchangeable grip 1102 may be changed to accommodate the preference of a user of the light source mobility device 1100, for example to improve comfort, improve stability, reduce strain, or otherwise improve the quality of use of the light source mobility device 1100. The upper threaded plug 1104 may screw into an upper lock ring 1106 of the light source mobility device 1100. The upper lock ring 1106 may comprise a threaded connector that can be coupled by an opposing threaded connector, and the upper lock ring 1106 may be activated to lock the interchangeable grip 1102 into place in the light source mobility device 1100. The light source mobility device 1100 may comprise a light source configured to light up an environment in an area of a user of the light source mobility device 1100. For example, light-emitting diode (LED) lights 1114 are an exemplary type of light used to emit light in the light source mobility device 1100. The LEDs 1114 may be housed in a light casing, and a light diffuser may be coupled to the light casing to diffuse light emitted by the LEDs 1114. The LEDs 1114 may be powered by a battery 1116.

The battery 1116 may be housed inside a shaft of the light source mobility device 1100. The battery 1116 may be removable from the inside of the shaft of the light source mobility device 1100. The battery 1116 may be removable and disposable, or the battery 1116 may be removable and rechargeable. The battery 1116 may be rechargeable without removing the battery 1116 from the inside of the shaft of the light source mobility device 1100. For example, the charging port 1108 may couple to a charging cable of suitable type to charge the battery 1116. The charging port 1108 may comprise any suitable charging port, for example a USB-A port, a USB-B port, a mini-USB port, a micro-USB port, a USB-C port, a lightning port, or the like. The battery 1116 may provide power to circuitry of the light source mobility device 1100. For example, the battery 1116 may be coupled to a printed circuit board (PCB) 1112 of the light source mobility device 1100. The PCB may comprise circuitry configured to execute instructions to provide functionality to components of the light source mobility device 1100. For example, the PCB may execute instructions that cause the LEDs 1114 to increase in brightness, decrease in brightness, turn completely off, or the like. The PCB 1112 may comprise a positioning system component, for example a global positioning system (GPS) component. The GPS component 1112 may provide a geographical location of the light source mobility device 1100 to an external party. For example, the GPS component may be in communication with an external device, and a user associated with the external device may be able to determine a location of the light source mobility device 1100 using information provided by the GPS component. The PCB may be operable using the on/off button 1110.

The on/off button 1110 of the light source mobility device 1100 may operate the light source of the light source mobility device 1100. For example, the light source may be configured to operate in at least three power modes. For example, the light source may operate in a no power mode, in which the LEDs are powered off and emit no light. The light source may operate in a standby power mode, in which the LEDs 1114 emit a dim light. The dim light emitted by the LEDs 1114 in the standby power mode may not be suitably bright for a user to navigate an environment. The light source may operate in an active power mode, in which the LEDs 1114 emit a bright light. The bright light emitted by the LEDs 1114 in the active power mode may be suitable for a user of the light source mobility device 1100 to navigate a dark environment by providing light for the user to see when navigating the environment. The shaft may be coupled to a lower interchangeable shaft 1122 using a lower lock ring 1118 and a lower threaded plug 1120.

The lower threaded plug 1120 of the interchangeable shaft 1122 may be threaded and communicable with the threads of the lower lock ring 1118. The lower lock ring 1118 may engage the interchangeable shaft to prevent the interchangeable shaft 1122 from unscrewing from the lower lock ring threads 1118. The interchangeable shaft 1122 may comprise further useful elements. The interchangeable shaft 1122 may be switched to change a total length of the light source mobility device 1100. In another example (not shown), the light source mobility device 1100 may not comprise an interchangeable shaft 1122 or lower lock ring 1118.

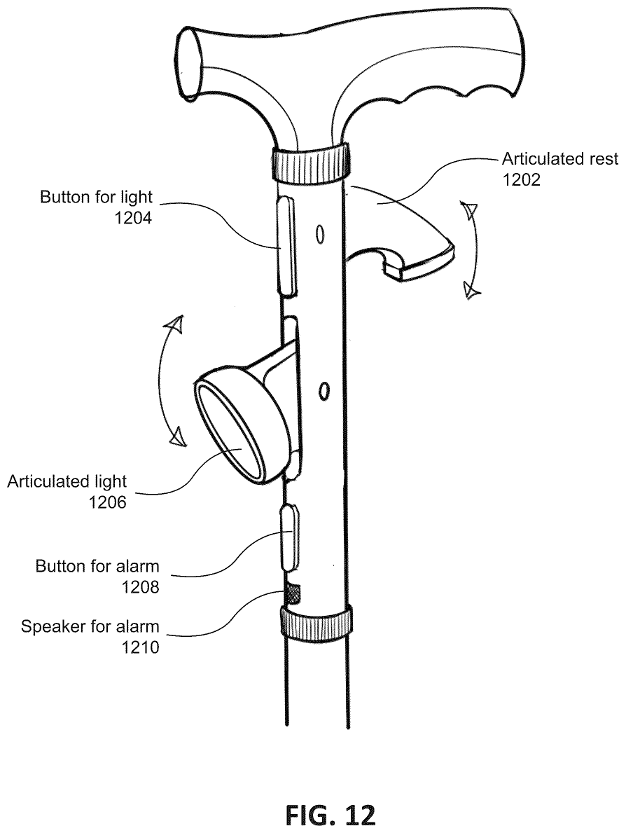

FIG. 12 shows another example light source mobility device. The light source mobility device may be configured to implement any one or more of the features of the attachable light source device noted above, with any one or more of the features of the attachable light source device built into the light source mobility device. For example, the light source mobility device may be a cane with any one or more of the features of the attachable light source device built-in. The light source mobility device is shown as a cane in FIG. 12, but the light source mobility device may be implemented as any suitable mobility device. For example, the features of the light source mobility device may be implemented in a walker, crutches, or a wheelchair.

The light source mobility device comprises an articulated rest 1202. The articulated rest may move along at least one axis. For example, the articulated rest 1202 may move along a plane that bisects the light source mobility device vertically. The articulated rest 1202 may be configured to allow the light source mobility device to rest against a surface. For example, a user may place the light source mobility device against a side of a table, and the articulated rest 1202 may rest upon the top of the table. The articulated rest 1202 may be configured to cause the light source mobility device to stay in place while resting against the table, or against any other suitable surface. For example, the light source mobility device may rest against a cabinet, a chair, a chair back, a counter, an appliance, a wall, or the like. The articulated rest 1202 may pivot to increase an amount of surface area of a face of the articulated rest 1202 to touch the surface. The face of the articulated rest 1202 may be comprised of a material with a high coefficient of friction. For example, the face of the articulated rest may comprise rubber, plastic, cloth, fabric, or any other suitable material or pattern to provide friction and prevent the light source mobility device from sliding off the surface.

The light source mobility device may have a button for light 1204 near the top of the device. The button for light 1204 may be a power button to operate a light. For example, the light source mobility device may comprise an articulated light 1206. The power button 1204 of the light source mobility device may operate a light source of the articulated light 1206. For example, the light source may be configured to operate in at least three power modes. For example, the light source may operate in a no power mode, in which the light source is powered off and emit no light. The light source may operate in a standby power mode, in which the light source emits a dim light. The dim light emitted by the light source in the standby power mode may not be suitably bright for a user to navigate an environment. The light source may operate in an active power mode, in which the light source emits a bright light. The bright light emitted by the light source of the articulated light 1206 in the active power mode may be suitable for a user of the light source mobility device to navigate a dark environment by providing light for the user to see when navigating the environment. The articulated light 1206 may be moved to provide a more efficient illumination of an environment of the user.

The light source mobility device may comprise a button for an alarm 1208. The button for alarm 1208 may be activated to activate an alarm associated with the light source mobility device. Upon operation of the button for alarm 1208, an alarm may activate. The alarm may comprise playing a particular sound, sending a signal, or emitting a light associated with an alarm. The alarm may comprise a forced air whistle, an electric whistle, a wireless signal, or any other suitable signal to communicate that a user associated with the light source mobility device is in distress. A speaker for alarm 1210 is shown and may emit a sound or voice associated with the alarm.

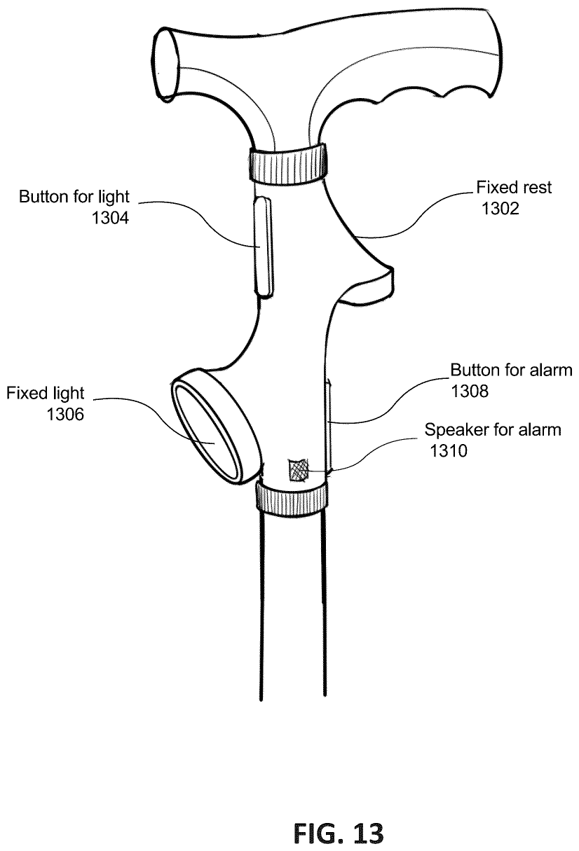

FIG. 13 shows another example light source mobility device. The light source mobility device may be configured to implement any one or more of the features of the attachable light source device noted above, with any one or more of the features of the attachable light source device built into the light source mobility device. For example, the light source mobility device may be a cane with any one or more of the features of the attachable light source device built-in. The light source mobility device is shown as a cane in FIG. 13, but the light source mobility device may be implemented as any suitable mobility device. For example, the features of the light source mobility device may be implemented in a walker, crutches, or a wheelchair.

The light source mobility device comprises a fixed rest 1302. The fixed rest 1302 may not move along any axes. The fixed rest 1302 may be configured to assist the light source mobility device to rest against a surface. For example, a user may place the light source mobility device against a side of a table, and the fixed rest 1302 may rest upon the top of the table. The fixed rest 1302 may be configured to cause the light source mobility device to stay in place while resting against the table, or against any other suitable surface. For example, the light source mobility device may rest against a cabinet, a chair, a chair back, a counter, an appliance, a wall, or the like. The face of the fixed rest 1302 may be comprised of a material with a high coefficient of friction. For example, the face of the fixed rest 1302 may comprise rubber, plastic, cloth, fabric, or any other suitable material or pattern to provide friction and prevent the light source mobility device from sliding off the surface.

The light source mobility device may have a button for light 1304 near the top of the device. The button for light 1304 may be a power button to operate a light. For example, the light source mobility device may comprise a fixed light 1306. The power button 1304 of the light source mobility device may operate a light source of the fixed light 1306. For example, the light source may be configured to operate in at least three power modes. For example, the light source may operate in a no power mode, in which the light source is powered off and emit no light. The light source may operate in a standby power mode, in which the light source emits a dim light. The dim light emitted by the light source in the standby power mode may not be suitably bright for a user to navigate an environment. The light source may operate in an active power mode, in which the light source emits a bright light. The bright light emitted by the light source of the fixed light 1306 in the active power mode may be suitable for a user of the light source mobility device to navigate a dark environment by providing light for the user to see when navigating the environment. The fixed light 1306 may be moved to provide a more efficient illumination of an environment of the user.

The light source mobility device may comprise a button for an alarm 1308. The button for alarm 1308 may be activated to activate an alarm associated with the light source mobility device. Upon operation of the button for alarm 1308, an alarm may activate. The alarm may comprise playing a particular sound, sending a signal, or emitting a light associated with an alarm. The alarm may comprise a forced air whistle, an electric whistle, a wireless signal, or any other suitable signal to communicate that a user associated with the light source mobility device is in distress. A speaker for alarm 1310 is shown and may emit a sound or voice associated with the alarm.

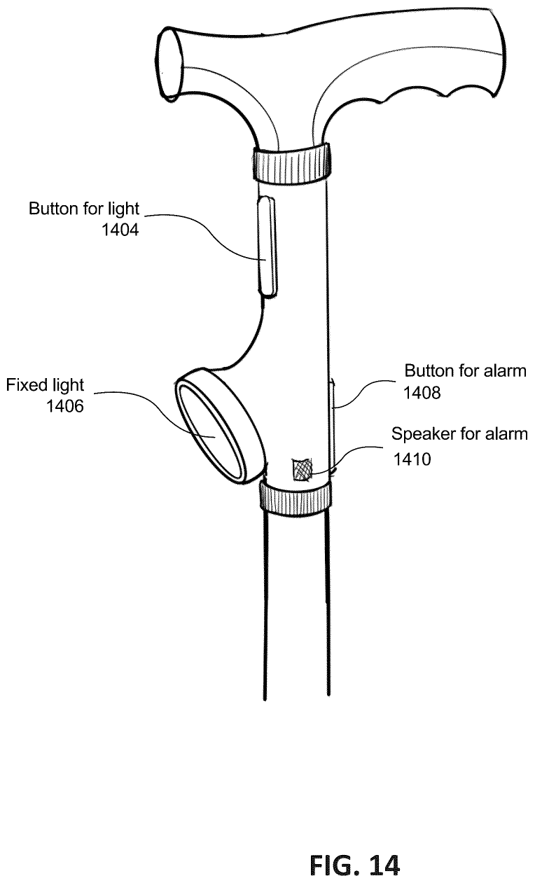

FIG. 14 shows another example light source mobility device. The light source mobility device may be configured to implement any one or more of the features of the attachable light source device noted above, with any one or more of the features of the attachable light source device built into the light source mobility device. For example, the light source mobility device may be a cane with any one or more of the features of the attachable light source device built-in. The light source mobility device is shown as a cane in FIG. 14, but the light source mobility device may be implemented as any suitable mobility device. For example, the features of the light source mobility device may be implemented in a walker, crutches, or a wheelchair.

The light source mobility device may have a button for light 1404 near the top of the device. The button for light 1404 may be a power button to operate a light. For example, the light source mobility device may comprise a fixed light 1406. The power button 1404 of the light source mobility device may operate a light source of the fixed light 1406. For example, the light source may be configured to operate in at least three power modes. For example, the light source may operate in a no power mode, in which the light source is powered off and emit no light. The light source may operate in a standby power mode, in which the light source emits a dim light. The dim light emitted by the light source in the standby power mode may not be suitably bright for a user to navigate an environment. The light source may operate in an active power mode, in which the light source emits a bright light. The bright light emitted by the light source of the fixed light 1406 in the active power mode may be suitable for a user of the light source mobility device to navigate a dark environment by providing light for the user to see when navigating the environment. The fixed light 1406 may be moved to provide a more efficient illumination of an environment of the user.

The light source mobility device may comprise a button for an alarm 1408. The button for alarm 1408 may be activated to activate an alarm associated with the light source mobility device. Upon operation of the button for alarm 1408, an alarm may activate. The alarm may comprise playing a particular sound, sending a signal, or emitting a light associated with an alarm. The alarm may comprise a forced air whistle, an electric whistle, a wireless signal, or any other suitable signal to communicate that a user associated with the light source mobility device is in distress. A speaker for alarm 1410 is shown and may emit a sound or voice associated with the alarm.

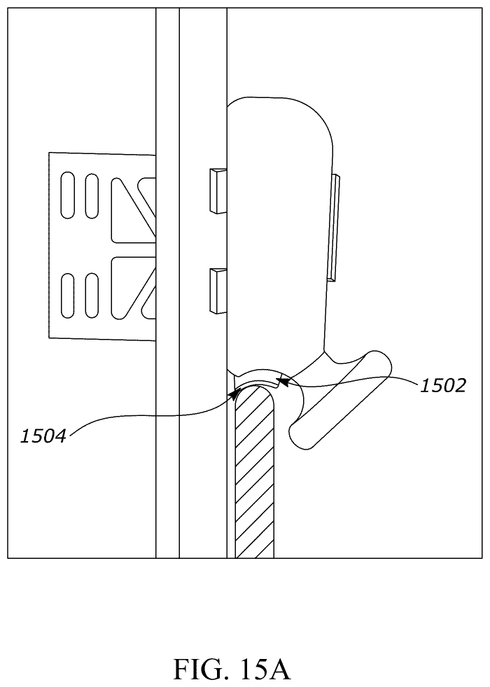

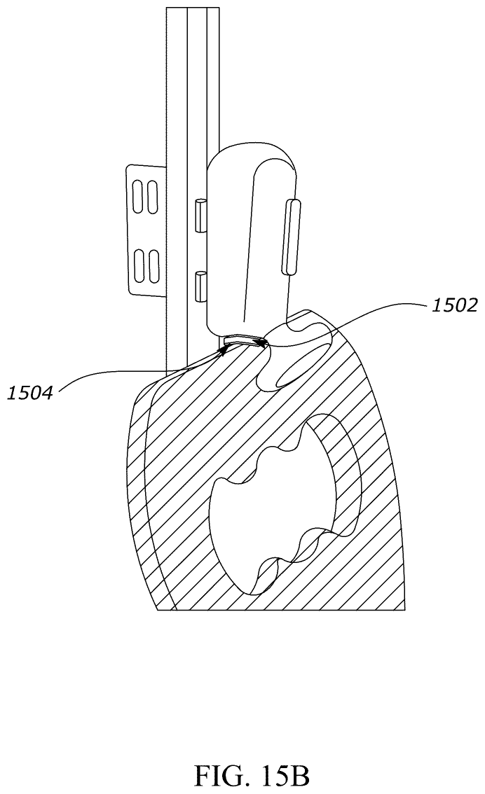

FIG. 15A shows a side view of an example anti-tip component associated with the attachable light source device described at least in FIGS. 9 and 10A-10E. FIG. 15B shows an example perspective view of the anti-tip component associated with the attachable light source device. The attachable light source device comprises an anti-tip component coupled to the bottom of the attachable light source device. The anti-tip component may be permanently coupled to the attachable light source device, or the anti-tip component of the attachable light source device may be removably coupled to the attachable light source device. The anti-tip component may comprise a first portion 1502 coupled directly to the attachable light source device. The first portion 1502 may comprise a material suitable for coupling the anti-tip component to the attachable light source device. For example, the first portion 1502 may comprise a hard plastic, metal, wood, or any other suitable material. The second portion 1504 of the anti-tip component may be configured to rest against another object to provide stability to the attachable light source device. The second portion 1504 of the anti-tip component may be comprised of any suitable material, for example rubber, plastic, cloth, fabric, or any pattern suitable for increasing friction between the second portion 1504 of the anti-tip component and another object.

For example, the attachable light source device may be coupled to a cane. The cane may be several feet long but only a few inches wide. The cane may not typically be able to stand upright on its own without tipping over. The attachable light source device may be coupled to the cane via a strap. The attachable light source device may have an anti-tip component. A user may rest the second portion of the anti-tip component 1504 against a surface, and the anti-tip component may prevent the cane from tipping over. For example, the second portion 1504 of the anti-tip component may be rested against a back of a chair. For example, the cane may not be touching the ground, and the second portion 1504 of the anti-tip feature may be the only portion of either the cane or the attachable light source device touching any other object. The anti-tip component may provide sufficient friction and support to prevent the cane from tipping over or otherwise moving. The attachable light source device may rest against a cabinet, a chair, a chair back, a counter, an appliance, a wall, or the like and prevent the cane and the attachable light source device from tipping over.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. An attachable light source device, comprising:
a body;
a movable, activatable light source coupled to the body, wherein the light source comprises a first light emission in a standby power mode, a second, brighter light emission in an active power mode, and no light emission in an off power mode;
a button configured to change the power mode of the light source; and
an attachment device configured to removably couple the attachable light source device to another device.

2. The attachable light source device of claim 1, further comprising, a rechargeable battery and a charging port associated with the rechargeable battery, wherein the rechargeable battery is configured to be recharged via the charging port.

3. The attachable light source device of claim 1, further comprising a removable, rechargeable battery.

4. The attachable light source device of claim 1, further comprising one or more touch sensors, wherein the attachable light source device is configured to be motion-activated in the standby power mode, and wherein the touch sensors are configured to cause transition from the standby power mode to the active power mode upon sensing touch imparted to either the attachable light source device or the another device that the attachable light source device is coupled to.

5. The attachable light source device of claim 1, wherein the attachment device comprises at least one of a stretchable fastener, a hook and loop fastener, a clasp fastener, or a clip fastener.

6. The attachable light source device of claim 1, further comprising a rest coupled to an underside of the attachable light source device, the rest comprising a structural portion coupled to the attachable light source device and a tread portion configured to rest against an external surface to arrest movement of the attachable light source device.

7. The attachable light source device of claim 1, wherein the another device comprises at least one of a cane, a walker, a crutch, a wheelchair, a pole, a ski, a manually-powered vehicle, a motor vehicle, furniture, a bag, or clothing.

8. The attachable light source device of claim 1, further comprising a geographical positioning component, wherein the geographical positioning component is configured to determine a geographical position of the attachable light source device, and wherein the geographical positioning component is configured to communicate with an external system to indicate the geographical position of the attachable light source device.

9. A light source mobility aid device, comprising:
a handle coupled to a proximal end of a shaft; and
the shaft, further comprising:
a movable, activatable light source powered by a battery, the battery situated inside the shaft, wherein the activatable light source is configured to operate in a plurality of power modes, wherein the plurality of power modes comprises:
an active power mode comprising a first light level emitted from the movable, activatable light source;
a standby power mode comprising a second, dimmer light level emitted from the movable, activatable light source than the first light level; and
an off power mode comprising no light emitted from the movable, activatable light source; and
a button configured to change the power mode of the activatable light source.

10. The light source mobility aid device of claim 9, wherein the battery is a rechargeable battery, further comprising a charging port associated with charging the battery.

11. The light source mobility aid device of claim 9, further comprising a selective opening of the shaft, wherein the battery is configured to be removed via the selective opening of the shaft.

12. The light source mobility aid device of claim 9, further comprising a positioning device situated inside the shaft, wherein the positioning device is configured to determine a geographical position of the light source mobility device, and wherein the positioning device is configured to communicate with an external system to indicate the geographical position.

13. The light source mobility aid device of claim 9, wherein the shaft comprises a connector at the proximal end, and wherein the handle is removably coupled to the shaft via the connector at the proximal end.

14. The light source mobility aid device of claim 13, wherein the connector comprises a threaded connector.

15. The light source mobility aid device of claim 9, wherein the shaft comprises a connector at a distal end of the shaft, and wherein at least one of a foot or an additional shaft is configured to be coupled to the shaft via connector at the distal end of the shaft.

16. The light source mobility aid device of claim 9, wherein the movable, activatable light source is configured to rotate on an axis perpendicular to a length of the shaft.

17. The light source mobility aid device of claim 9, further comprising an alarm device situated inside the shaft, wherein the alarm device is configured to determine a presence of an alarm condition and at least one of activate a sound, send a distress signal, or activate a light in response to determining the alarm condition.

18. The light source mobility aid device of claim 17, further comprising an alarm button, wherein the alarm device is configured to determine the presence of the alarm condition based on activation of the alarm button.

19. The light source mobility aid device of claim 9, further comprising a rest protruding from a side of the shaft, the rest comprising a structural portion coupled to the shaft and a tread portion configured to rest against an external surface to arrest movement of the light source mobility aid device.

20. The light source mobility aid device of claim 19, wherein the rest is at least one of fixed in place or articulated, wherein the articulated rest may move on an axis perpendicular to a length of the shaft.
